(19) United States
(12) Patent Application Publication
(10) Pub. No.: US 2017/0229931 A1
(43) Pub. Date: Aug. 10, 2017

(54) MOTOR LAMINATION MITIGATING TORQUE CONSTANT ROLL OFF

(71) Applicant: Moog Inc., East Aurora, NY (US)

(72) Inventors: Lee L. Snider, Christiansburg, VA (US); Charles James Ford, Blacksburg, VA (US); Matthew Allen Carroll, Christiansburg, VA (US); Ronald G. Flanary, II, Blacksburg, VA (US)

(21) Appl. No.: 15/040,381

(22) Filed: Feb. 10, 2016

(51) Int. Cl. H02K 1/18; H02K 15/02; H02K 3/52; H02K 1/14; H02K 3/18

(52) U.S. Cl. CPC H02K 1/185; H02K 1/14; H02K 3/18; H02K 3/522; H02K 15/022

(57) ABSTRACT

A straight line lamination for an electric motor has alternating finger segments and hinge segments to be rollable after windings are installed to form a circular motor stator. The lamination is configured such that inner edges of a back iron region are non-arcuate in shape to provide extra back iron material near the hinge segments for mitigating torque constant roll off.

### FIELD OF THE INVENTION

The present invention relates generally to electric motors, and more particularly to laminations for making an electric motor stator.

### BACKGROUND OF THE INVENTION

In a system with an electric motor, it is desirable to keep the torque constant of the motor as linear as possible when the motor is subjected to high intermittent torque demands. If the torque constant rolls off (i.e., degrades and becomes non-linear) and the motor laminations have not reached magnetic saturation, then additional current may be supplied to the motor to compensate for the degraded torque constant. However, if the iron in the motor laminations has reached magnetic saturation, then roll off of the torque constant cannot be compensated for by increasing the current.

To accomplish a linear torque constant over a specified operating torque range, the iron associated with the stator must be sufficient to support the necessary magnetic flux levels. Therefore, the motor laminations are designed with enough iron so that the torque constant remains linear over the expected operating torque range. However, adding ferrous material to the laminations takes away physical space available for the motor windings. As the physical space for the motor windings is decreased, the motor resistance increases, which causes additional heating and changes the motor's time constant.

Applicant has designed a motor having an optimal torque constant linearity. The design uses conventional circular laminations onto which windings are inserted. Although suitable torque constant linearity is achieved, the motor is not cost effective to manufacture in high production volumes. To enable this motor to be manufactured in high volumes in a cost effective manner, a manufacturing process was adopted whereby the laminations are formed as straight line laminations and then rolled to form a circular stator after the copper windings are installed. In the straight line laminations, the fingers that receive the copper windings are arranged as a plurality of parallel fingers spaced apart from one another by slot areas along a longitudinal axis of the laminations. The winding step is performed while the fingers are parallel and there is easy access and space for winding machinery. The wound laminations are then rolled into a circular configuration in which the fingers extend radially toward a central axis of the motor. This process maximizes the amount of copper winding in the slot areas allocated for copper, and therefore minimizes the overall axial length of the motor for a given motor constant.

Winding the laminations while they are straight and then rolling the wound laminations into a circular stator requires that a back iron region of the laminations be configured with bendable hinge features between the fingers. The hinge features are formed by adding voids in the laminations so that adjacent fingers of the lamination are connected by a thin strip of lamination material acting as the hinge feature. However, providing the hinge features reduces the amount of material in the back iron region of the laminations, thus causing the torque constant to roll off at lower torque demands than the conventional circular lamination version of the motor.

### SUMMARY OF THE INVENTION

Therefore, it is an object of the present invention to provide a rollable motor lamination that does not compromise torque constant linearity relative to a comparable circular motor lamination.

In an embodiment of the present invention, a motor lamination defines a plurality of finger segments spaced along a longitudinal axis, and a plurality of hinge segments respectively between adjacent pairs of the finger segments. Each finger segment has a reference center, a back iron region, and a finger projecting from the back iron region along a finger axis extending perpendicular to the longitudinal axis of the lamination. The back iron region includes a pair of lateral edges each extending in a respective radial direction relative to the reference center of the finger segment, and a pair of inner edges each extending from the finger to an associated one of the lateral edges. Each inner edge is non-arcuate in shape. For example, the inner edge may have a first straight edge portion extending perpendicular to the radial direction of the associated lateral edge. When the lamination is rolled into circular form, each first straight edge portion aligns with another first straight edge portion of an adjacent finger segment, such that the rolled lamination has a plurality of non-arcuate inner edges bounding slot areas for the motor windings. The resulting inner edge configuration provides extra back iron material in the lamination to compensate for back iron material omitted to define the hinge segments and maintain a desired torque constant linearity.

The invention is also embodied by an electric motor stator that comprises a stack of laminations defining a ring-shaped back iron and a plurality of angularly-spaced fingers separated by a plurality of angularly-spaced slot areas, wherein each of the fingers extends radially inward from the back iron toward a central axis of the stack along a respective radial finger axis and each of the slot areas has a respective radial slot axis. The back iron has a plurality of inner edges each extending between an angularly adjacent pair of the fingers and bounding an associated one of the slot areas. In accordance with the invention, each of the inner edges includes at least one non-arcuate edge portion. The inner edges may have a plurality of straight edge portions. For example, the each inner edge may have a pair of straight transition portions connected by a bridge portion. The bridge portion may also be straight, and may extend perpendicular to the radial slot axis of the associated slot area. By configuring the inner edges in this way, extra back iron material is provided for mitigating torque constant roll off.

### BRIEF DESCRIPTION OF THE DRAWINGS

The nature and mode of operation of the present invention will now be more fully described in the following detailed description of the invention taken with the accompanying drawing figures, in which:

FIG. 1 is a plan view of a straight line motor lamination formed in accordance with an embodiment of the present invention;

FIG. 2 is a plan view of the motor lamination shown in FIG. 1, after the motor lamination has been rolled into a circular form;

FIG. 3 is an enlarged view of a finger segment and a hinge segment of the straight line motor lamination of FIG. 1;

FIG. 4 is an approximate plan view showing a stack of straight line motor laminations after copper windings are applied to the lamination fingers; and

FIG. 5 is a plan view of a motor stator formed from the stack of wound laminations shown in FIG. 4.

### DETAILED DESCRIPTION OF THE INVENTION

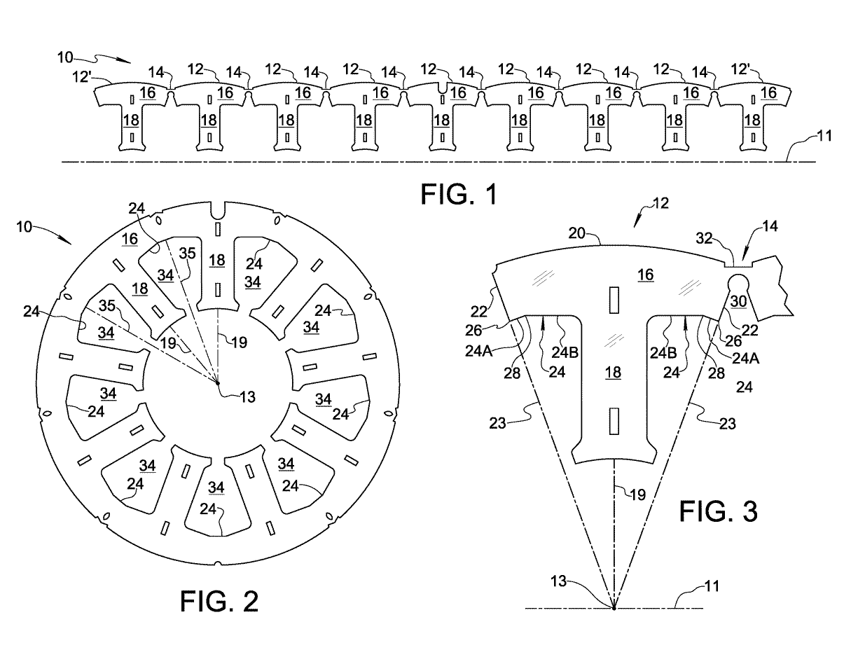

FIG. 1 is a plan view of a lamination 10 formed in accordance with an embodiment of the present invention. Lamination 10 is used in manufacturing a stator of an electric motor. Lamination 10 is a straight line lamination extending along a longitudinal axis 11. As will be explained in greater detail below, lamination 10 is capable of being rolled into a circular form as depicted in FIG. 2.

Lamination 10 is cut from a sheet of lamination material. The shape of lamination 10 defines a plurality of finger segments 12 spaced along the longitudinal axis 11, and a plurality of hinge segments 14 respectively between adjacent pairs of finger segments 12. Each finger segment 12 has a reference center 13, a back iron region 16, and a finger 18 projecting from back iron region 16 along a finger axis 19 extending perpendicular to longitudinal axis 11.

Reference is also made to FIG. 3, which shows one of the finger segments 12 at the end of lamination 10 in enlarged detail. As may be seen, the back iron region 16 of finger segment 12 includes an outer circumferential edge 20, a pair of lateral edges 22, and a pair of inner edges 24. Each lateral edge 22 extends in a respective radial direction 23 relative to reference center 13. Inner edges 24 extend from finger 18 to an associated one of the lateral edges 22. Each of the inner edges 24 has a first straight edge portion 24A and a second straight edge portion 24B. In the illustrated embodiment, the first straight edge portion 24A of each inner edge 24 extends perpendicular to the radial direction 23 of the associated lateral edge 22 and intersects with the associated lateral edge 22 at a corner 26. The second straight edge portion 24B of each inner edge 24 may extend from finger 18 to first straight edge portion 24A, and may intersect with first straight edge portion 24A at a corner 28. Each second straight edge portion 22B may extend perpendicular to the finger axis 19 so as to define a maximized and unobstructed open slot space for installing a copper winding about finger 18.

FIG. 3 also shows one of the hinge segments 14 in enlarged detail. Hinge segment 14 is defined by a mouth opening 30 between facing lateral edges 22 of adjacent finger segments 12, and by an outer recess 32 in circumferential edge 20. As may be seen, hinge segment 14 may be embodied as a thin strip of lamination material connecting two adjacent finger segments 12. Mouth opening 30 and outer recess 32 may be omitted with respect to the finger segments 12′ at opposite ends of lamination 10 because the end finger segments are ultimately connected to one another when lamination 10 is rolled into a circular configuration.

Referring again to FIG. 2, the circular form of rolled lamination 10 comprises a plurality of angularly-spaced fingers 18 separated by a plurality of angularly-spaced slot areas 34 each having a respective radial slot axis 35. When lamination 10 is rolled into a circular form, an inner edge 24 of one finger segment 12 will merge with an inner edge 24 of an adjacent finger segment 12 to form an inner edge 24 that extends from one finger 18 to the next finger 18. The resulting inner edges 24 of the circular lamination are non-arcuate.

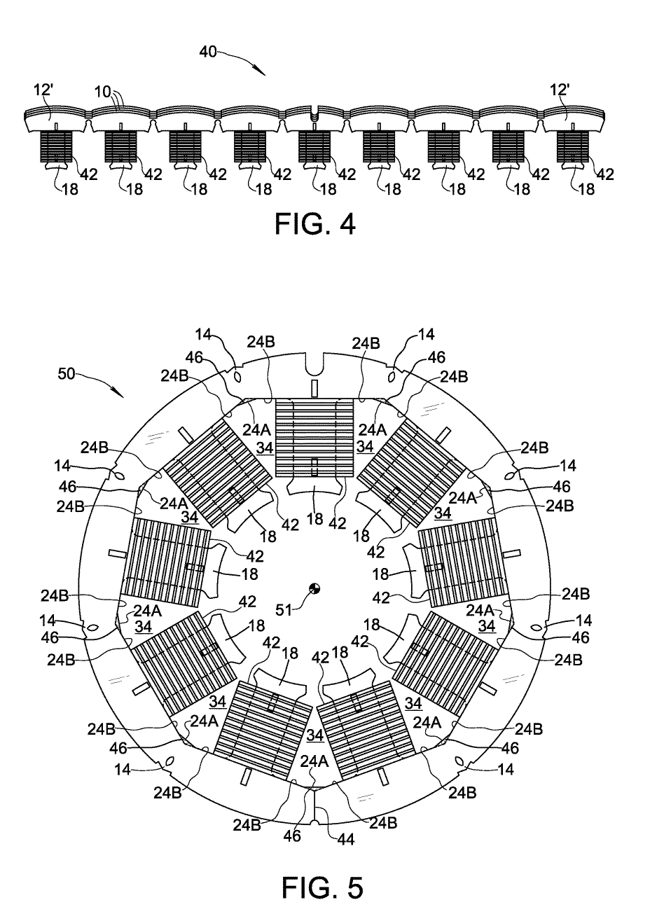

FIG. 4 shows a stack 40 of laminations 10 in plan view, with copper windings 42 provided around fingers 18 of laminations 10 while the laminations 10 are in their original straight line configuration. Windings 42 may be installed using an automatic motor winding machine. After windings 42 are installed, the wound stack 40 of laminations is rolled into circular form as shown in FIG. 5, and the end finger segments 12′ of the laminations are joined to one another at a weld seam 44 to form a stator 50. Consequently, stator 50 comprises a central axis 51 and a plurality of fingers 18 and a plurality of slot areas 34 angularly-spaced about central axis 51 in alternating fashion.

As may be seen in FIG. 5, each inner edge 24 of stator 50 has at least one non-arcuate edge portion. In the depicted embodiment, each of the inner edges 24 has a plurality of straight edge portions, namely a first straight edge portion 24A in between a pair of second straight edge portions 24B. The pair of second straight edge portions 24B act as transition portions and may extend away from a corresponding finger 18 in a direction perpendicular to the radial finger axis 19 of the corresponding finger, and the first straight edge portion 24A acts as a bridge portion connecting the pair of straight transition portions 24B. Bridge portion 24A may extend perpendicular to the radial slot axis 35 of the slot area 34 bounded by inner edge 24. While bridge portion 24A is depicted as a straight edge portion in the exemplary embodiment, it is understood that bridge portion 24A may be convex to project inward toward central axis 51.

The novel configuration of inner edges 24 departs from traditional use of an inner edge that is simply a circular arc from one finger to the next to provide extra back iron material at regions 46 associated with hinge segments 14, thereby making up for the loss of back iron material due to formation of hinge segments 14. By mitigating torque constant roll off affects, the present invention allows for use of straight line laminations 10 for more efficient stator production without sacrificing torque constant linearity.

While the invention has been described in connection with exemplary embodiments, the detailed description is not intended to limit the scope of the invention to the particular forms set forth. The invention is intended to cover such alternatives, modifications and equivalents of the described embodiment as may be included within the scope of the invention.

What is claimed is:

1. A motor lamination comprising:
a longitudinal axis;
a single sheet of lamination material defining a plurality of finger segments spaced along the longitudinal axis and a plurality of hinge segments respectively between adjacent pairs of the finger segments;
wherein each finger segment has a reference center, a back iron region, and a finger projecting from the back iron region along a finger axis extending perpendicular to the longitudinal axis;
wherein the back iron region includes a pair of lateral edges, each lateral edge extending in a respective radial direction relative to the reference center;
wherein the back iron region further includes a pair of inner edges extending from the finger to an associated one of the lateral edges, wherein each of the inner edges is non-arcuate.

2. The lamination according to claim 1, wherein each of the inner edges has a first straight edge portion extending perpendicular to the radial direction of the associated lateral edge.

3. The lamination according to claim 2, wherein each of the first straight edge portions intersects with the associated lateral edge.

4. The lamination according to claim 3, wherein each of the inner edges further has a second straight edge portion extending from the finger to the first straight edge portion.

5. The lamination according to claim 4, wherein the second straight edge portion extends perpendicular to the finger axis.

6. A stator of an electric motor, the stator comprising:
a stack of laminations defining a ring-shaped back iron and a plurality of angularly-spaced fingers separated by a plurality of angularly-spaced slot areas;
a central axis located off of the stack of laminations;
each of the fingers extending radially inward from the back iron toward the central axis along a respective radial finger axis and each of the slot areas having a respective radial slot axis; and
the back iron having a plurality of inner edges, each of the inner edges extending between an angularly adjacent pair of the fingers and bounding an associated one of the slot areas;
wherein each of the inner edges includes at least one non-arcuate edge portion.

7. The stator according to claim 6, wherein each of the inner edges has a plurality of straight edge portions.

8. The stator according to claim 7, wherein each of the inner edges has a pair of straight transition portions extending away from a corresponding one of the pair of fingers in a direction perpendicular to the radial finger axis of the corresponding finger, and each of the inner edges further has a bridge portion connecting the pair of straight transition portions.

9. The motor lamination according to claim 8, wherein the bridge portion is straight and extends in a direction perpendicular to the radial slot axis of the associated slot area.
